(19) United States
(12) Patent Application Publication
(10) Pub. No.: US 2015/0124312 A1
(43) Pub. Date: May 7, 2015

(54) DISPLAY UNIT AND ELECTRONIC APPARATUS

(71) Applicant: Sony Corporation, Tokyo (JP)

(72) Inventors: Masakazu Mitsugi, Kanagawa (JP); Atsuhito Yasui, Kanagawa (JP); Hidehiko Takanashi, Kanagawa (JP); Ken Kobayashi, Kanagawa (JP); Yuriko Kaino, Kanagawa (JP); Aya Shuto, Kanagawa (JP); Satoko Asaoka, Kanagawa (JP); Yasuyuki Kudo, Miyagi (JP); Ryo Kasegawa, Kanagawa (JP)

(73) Assignee: Sony Corporation, Tokyo (JP)

(21) Appl. No.: 14/526,659

(22) Filed: Oct. 29, 2014

(30) Foreign Application Priority Data
Nov. 7, 2013 (JP) 2013-231186

(51) Int. Cl. G02F 1/167; G02F 1/1335; G02F 1/1333

(52) U.S. Cl. CPC G02F 1/167; G02F 1/133348; G02F 1/133553
USPC 359/296

(57) ABSTRACT

A display unit includes: a first substrate; a second substrate facing the first substrate; a display layer provided between the first substrate and the second substrate and allowed to control light transmission or light reflection; and a seal layer including an additive and provided between the first substrate and the display layer.

### CROSS REFERENCE TO RELATED APPLICATIONS

This application claims the benefit of Japanese Priority Patent Application JP 2013-231186 filed Nov. 7, 2013, the entire contents which are incorporated herein by reference.

### BACKGROUND

The present technology relates to a display unit including a display layer capable of controlling light transmission or light reflection, and an electronic apparatus including the display unit.

In recent years, demand for display units with low power consumption and high image quality have been growing with the widespread use of mobile devices such as cellular phones and personal digital assistants. In particular, the recent launch of electronic book distribution service causes demand for displays with display quality suitable for reading.

As such displays, there have been proposed various kinds of displays including cholesteric liquid crystal displays, electrophoretic displays, electrical oxidation-reduction displays, and twisting ball displays; however, reflective displays are advantageous for reading. As with paper, the reflective displays perform display in a bright state with use of reflection (scattering) of outside light; therefore, display quality closer to that of paper is obtainable in the reflective displays.

In the reflective displays, electrophoretic displays using an electrophoretic phenomenon have low power consumption and high response speed; therefore, the electrophoretic displays are considered as potential candidates. In the electrophoretic displays, two kinds of charged particles are dispersed in an insulating liquid to be moved by an electric field. These two kinds of charged particles have different reflection properties from each other, and are opposite in polarity.

Such electrophoretic displays are formed by separately fabricating a display body and a TFT (Thin Film Transistor) substrate where a drive transistor and the like are formed, and then bonding the display body and the TFT substrate together. In a case where such a manufacturing method is used, it is necessary to form the display body in a sheet shape. To form the display body in a sheet shape, it is necessary to provide a seal layer on a back surface (a bonding surface) of the display body, and the display body and the TFT substrate are bonded together with the seal layer in between (for example, refer to Japanese Unexamined Patent Application Publication No. 2012-22296).

### SUMMARY

The seal layer may be formed of, for example, a thermoplastic resin. The thermoplastic resin is superior in heat resistance, adhesion, process adaptability, electrical properties, and the like; however, the thermoplastic resin is chemically incompatible with an electrophoretic dispersion liquid, thereby causing a reduction in display characteristics of the electrophoretic displays.

It is desirable to provide a display unit capable of improving display characteristics, and an electronic apparatus.

According to an embodiment of the present technology, there is provided a display unit including: a first substrate; a second substrate facing the first substrate; a display layer provided between the first substrate and the second substrate and allowed to control light transmission or light reflection; and a seal layer including an additive and provided between the first substrate and the display layer.

According to an embodiment of the present technology, there is provided an electronic apparatus provided with a display unit, the display unit including: a first substrate; a second substrate facing the first substrate; a display layer provided between the first substrate and the second substrate and allowed to control light transmission or light reflection; and a seal layer including an additive and provided between the first substrate and the display layer.

In the display unit according to the embodiment of the present technology, surface properties of the seal layer are improved with use of the additive in the seal layer provided between the display layer and the first substrate.

In the display unit and the electronic apparatus according to the embodiments of the present technology, the additive is used in the seal layer provided between the display layer and the first substrate; therefore, the surface properties of the seal layer is improved and thus display characteristics are allowed to be improved. It is to be noted that effects of the embodiments of the present technology are not limited to effects described here, and any effects described in the present disclosure may be included.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a sectional view illustrating a configuration of a display unit according to an embodiment of the present technology.

FIG. 2 is a plan view illustrating a configuration of an electrophoresis device illustrated in FIG. 1.

FIG. 3 is a sectional view for describing an operation of the display unit illustrated in FIG. 1.

FIG. 4 is a sectional view illustrating a configuration of a display unit according to a modification example of the present technology.

FIG. 5A is a perspective view illustrating an appearance of Application Example 1.

FIG. 5B is a perspective view illustrating another example of an electronic book illustrated in FIG. 5A.

FIG. 6 is a perspective view illustrating an appearance of Application Example 2.

FIG. 7 is a perspective view illustrating an appearance of Application Example 3.

FIG. 8A is a perspective view illustrating an appearance viewed from a front side of Application Example 4.

FIG. 8B is a perspective view illustrating an appearance viewed from a back side of Application Example 4.

FIG. 9 is a perspective view illustrating an appearance of Application Example 5.

FIG. 10 is a perspective view illustrating an appearance of Application Example 6.

FIG. 11A is a front view, a left side view, a right side view, a top view, and a bottom view in a state in which Application Example 7 is closed.

FIG. 11B is a front view and a side view in a state in which Application Example 7 is opened.

FIG. 12A is a characteristic diagram illustrating a relationship between an addition amount of an additive and response speed in Example 2 of the present technology.

FIG. 12B is a characteristic diagram illustrating a relationship between the addition amount of the additive and reflectivity in Example 2.

FIG. 13A is a characteristic diagram illustrating a relationship between an addition amount of an additive and response speed in Example 2.

FIG. 13B is a characteristic diagram illustrating a relationship between the addition amount of the additive and reflectivity in Example 2.

FIG. 14A is a characteristic diagram illustrating a relationship between an addition amount of an additive and response speed in Example 2.

FIG. 14B is a characteristic diagram illustrating a relationship between the addition amount of the additive and reflectivity in Example 2.

FIG. 15A is a characteristic diagram illustrating a relationship between an additive (anionic) and volume resistivity of a seal layer in Example 2.

FIG. 15B is a characteristic diagram illustrating a relationship between an additive (nonionic) and volume resistivity of the seal layer in Example 2.

### DETAILED DESCRIPTION

Some embodiments of the present technology will be described in detail below referring to the accompanying drawings. It is to be noted that description will be given in the following order.

1. Embodiment (Electrophoretic display unit: Example in which an additive is added to a seal layer)

2. Modification Example (Example in which a seal layer is dyed)

3. Application Examples

4. Examples

### 1. Embodiment

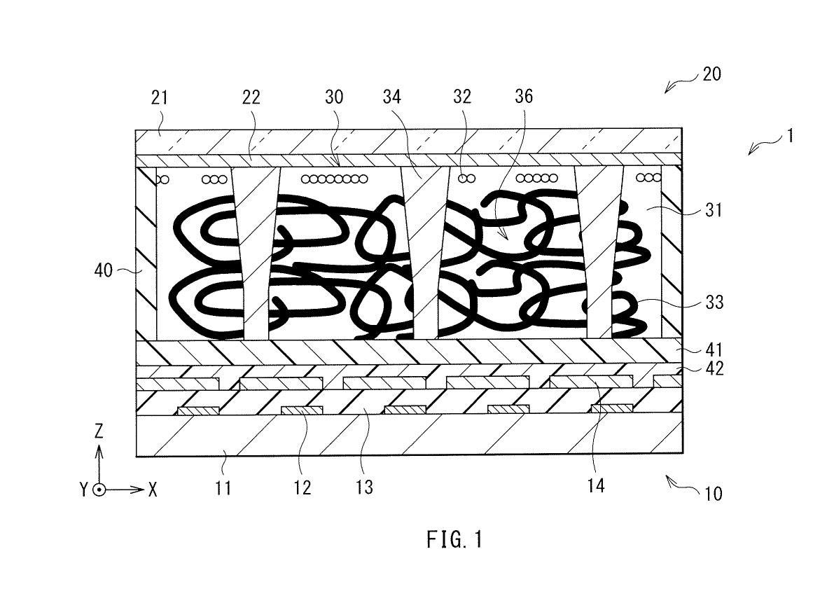

FIG. 1 illustrates a sectional configuration of a display unit (a display unit 1) according to an embodiment of the present disclosure. The display unit 1 is an electrophoretic display unit configured to display an image with use of an electrophoretic phenomenon, and includes an electrophoresis device 30 as a display body between a drive substrate 10 and a counter substrate 20. A spacer 40 is formed in a gap between the drive substrate 10 and the counter substrate 20, and an image is displayed on the counter substrate 20. It is to be noted that FIG. 1 schematically illustrates a configuration of the display unit 1, and dimensions and a shape of the display unit 1 may be different from actual dimensions and an actual shape.

The electrophoresis device 30 includes migrating particles 32 and a porous layer 33 in an insulating liquid 31. The electrophoresis device 30 is formed on the counter substrate 20, and is sealed by a seal layer 41. In this embodiment, an additive is included in the seal layer 41. The electrophoresis device 30 is laminated on the drive substrate 10 with the seal layer 41 and an adhesive layer (an adhesive layer 42 that will be described later) in between. The electrophoresis device 30 is applicable to various uses. A case where the electrophoresis device 30 is applied to the display unit 1 will be described below; however, the configuration of the display unit 1 is merely an example, and may be modified as appropriate. Moreover, the electrophoresis device 30 may be used for units other than display units, and the application of the electrophoresis device 30 is not specifically limited.

The seal layer 41 is configured to form the counter substrate 20 including the electrophoresis device 30 in a sheet shape by sealing an insulating liquid (the insulating liquid 31 that will be described later) in the electrophoresis device 30, and to prevent entry of water into the electrophoresis device 30. The seal layer 41 in this embodiment may have, for example, a configuration in which an additive is added to a thermoplastic resin or the like as a base material. Specific examples of the base material may include a urethane-based resin, an acrylic-based resin, and a polyester-based resin. More specifically, polyurethane with an average molecular weight of about 1000 to about 100000 both inclusive may be preferably used. The additive is provided to improve surface properties of the seal layer 41. More specifically, the additive is provided to suppress absorption of migrating particles 32 configuring the electrophoresis device 30 to a surface of the seal layer 41, and may preferably have, for example, an acid structure in a molecule. The additive may preferably have an average molecular weight of about 100 to about 100000 both inclusive, and an addition amount of the additive may be within a range of about 0.01 wt % to about 10 wt % both inclusive. Specific examples of the additive may include a surfactant and a dispersant.

Examples of the surfactant may include an anionic surfactant having an acid structure in a molecule and a nonionic surfactant having an acid structure in a molecule. More specifically, an anionic surfactant having, for example, a carboxylic acid structure, a sulfonic acid structure, or a phosphoric acid structure in a molecule, or a nonionic surfactant having, for example, an ester structure or an ether structure in a molecule may be preferably used. Moreover, the surfactant may be preferably hydrophilic, and may preferably have, for example, an HLB (Hydrophile-Lipophile Balance) value of about 10 or more. It is to be noted that the HLB value of the surfactant may be preferably about 10 or more, but does not necessarily exclude less than about 10.

As the surfactant used as the additive, the anionic surfactant and the nonionic surfactant may be used either alone or in combination. Moreover, a combination of one or more kinds of anionic surfactants and one or more kinds of nonionic surfactants may be used. As described above, the addition amount of the surfactants may be preferably within a range of about 0.01 wt % to about 10 wt % both inclusive, and more preferably within a range of about 0.01 wt % to about 5 wt % both inclusive. It is to be noted that, since the anionic surfactant has a high effect of improving surface properties of the seal layer 41, a sufficient effect is obtained with about 2 wt % or less of the anionic surfactant.

The drive substrate 10 may include, for example, TFTs (Thin Film Transistors) 12, a protective layer 13, and pixel electrodes 14 in this order on one surface of a supporting member 11. The TFTs 12 and the pixel electrodes 14 may be arranged, for example, in a matrix form or a segment form according to a pixel arrangement.

The supporting member 11 may be configured of, for example, a plate-like inorganic material, a plate-like metal material, or a plate-like plastic material. Examples of the inorganic material may include silicon (Si), silicon oxide (SiO_{X}), silicon nitride (SiN_{X}), and aluminum oxide (AlOₓ). Examples of silicon oxide may include glass and spin-on glass (SOG). Examples of the metal material may include aluminum (Al), nickel (Ni), and stainless steel. Examples of the plastic material may include polycarbonate (PC), polyethylene terephthalate (PET), polyethylene naphthalate (PEN), and polyethyl ether ketone (PEEK).

In the display unit 1, since an image is displayed on the counter substrate 20, the supporting member 11 may be non-transparent to light. The supporting member 11 may be configured of a substrate with rigidity such as a wafer, or may be configured of a flexible thin glass, a flexible film, or the like. The flexible (foldable) display unit 1 is achievable by using a flexible material for the supporting member 11.

Each of the TFTs 12 is a switching device for selection of a pixel. Each of the TFTs 12 may be an inorganic TFT using an inorganic semiconductor layer as a channel layer, or an organic TFT using an organic semiconductor layer as a channel layer. The protective layer 13 may be made of, for example, an insulating resin material such as polyimide, and is configured to planarize a surface provided with the TFTs 12 of the supporting member 11. The pixel electrodes 14 may be formed of, for example, a conductive material such as gold (Au), silver (Ag), copper (Cu), Al, an Al alloy, or indium oxide-tin oxide (ITO). The pixel electrodes 14 may be made of a plurality of kinds of conductive materials. The pixel electrode 14 is connected to the TFT 12 through a contact hole (not illustrated) provided to the protective layer 13.

The counter substrate 20 may include, for example, a supporting member 21 and a counter electrode 22, and the counter electrode 22 is disposed on an entire surface (an entire surface facing the drive substrate 10) of the supporting member 21. As with the pixel electrodes 14, the counter electrode 22 may be arranged in a matrix form or a segment form.

For the supporting member 21, a material similar to that of the supporting member 11 may be used, as long as the material is transparent to light. For the counter electrode 22, for example, a light-transmissive conductive material (a transparent electrode material) such as ITO, antimony oxide-tin oxide (ATO), fluorine-doped tin oxide (FTO), or aluminum-doped zinc oxide (AZO) may be used.

Since the electrophoresis device 30 is viewed through the counter electrode 22 in the display unit 1, light transparency (transmittance) of the counter electrode 22 may be preferably as high as possible, and may be, for example, about 80% or more. Moreover, electrical resistance of the counter electrode 22 may be preferably as low as possible, and may be, for example, about 100 ohm/sq or less.

The electrophoresis device 30 is configured to provide contrast with use of the electrophoretic phenomenon, and includes migrating particles 32, the porous layer 33, and a partition wall 34.

A space enclosed by the drive substrate 10 (more specifically, the seal layer 41), the counter substrate 20, and the spacer 40 is filled with the insulating liquid 31, and the insulating liquid 31 may be made of, for example, an organic solvent such as paraffin or isoparaffin. As the insulating liquid 31, one kind of organic solvent or a mixture of a plurality of kinds of organic solvents may be used. Viscosity and a refractive index of the insulating liquid 31 may be preferably as low as possible. When the viscosity of the insulating liquid 31 is low, mobility (response speed) of the migrating particles 32 is improved. Accordingly, energy (power consumption) necessary for movement of the migrating particles 32 is reduced. When the refractive index of the insulating liquid 31 is low, a difference in refractive index between the insulating liquid 31 and the porous layer 33 is increased to increase light reflectivity of the porous layer 33. The refractive index of the insulating liquid 31 may be, for example, about 1.48.

For example, a colorant, a charge control agent (a charge regulation agent), a dispersion stabilizer, a viscosity modifier, a surfactant, a resin, or the like may be added to the insulating liquid 31.

The migrating particles 32 dispersed in the insulating liquid 31 are one or two or more charged particles (electrophoretic particles), and are movable through the porous layer 33 according to an electric field. The migrating particles 32 have an arbitrary optical reflection property (light reflectivity), and a difference in light reflectivity between the migrating particles 32 and the porous layer 33 provides contrast. In the display unit 1, the light reflectivity of the migrating particles 32 is lower than that of the porous layer 33, and display in a dark state is performed by the migrating particles 32, and display in a bright state is performed by the porous layer 33.

Therefore, when the electrophoresis device 30 is viewed from outside, the migrating particles 32 may be visually recognized, for example, as black or a color close to black. The color of the migrating particles 32 is not specifically limited, as long as contrast is allowed to be provided.

The migrating particles 32 may be configured of, for example, particles (powder) of an organic pigment, an inorganic pigment, a dye, a carbon material, a metal material, a metal oxide, glass, or a polymer material (a resin). For the migrating particles 32, one kind or two or more kinds selected from these materials may be used. The migrating particles 32 may be configured of pulverized particles, capsule particles, or the like of a resin solid including the above-described particles. It is to be noted that materials corresponding to the carbon material, the metal material, the metal oxide, the glass, and the polymer material are excluded from materials corresponding to the organic pigment, the inorganic pigment, and the dye.

Examples of the above-described organic pigment may include azo-based pigments, metal-complex azo-based pigments, polycondensation azo-based pigments, flavanthrone-based pigments, benzimidazolone-based pigments, phthalocyanine-based pigments, quinacridone-based pigments, anthraquinone-based pigments, perylene-based pigments, perinone-based pigments, anthrapyridine-based pigments, pyranthrone-based pigments, dioxazine-based pigments, thioindigo-based pigments, isoindolinone-based pigments, quinophthalone-based pigments, and indanthrene-based pigments. Examples of the inorganic pigments may include zinc white, antimony white, iron black, titanium boride, red iron oxide, Mapico Yellow, minium, cadmium yellow, zinc sulfide, lithopone, barium sulfide, cadmium selenide, calcium carbonate, barium sulfate, lead chromate, lead sulfate, barium carbonate, white lead, and alumina white. Examples of the dyes may include nigrosine-based dyes, azo-based dyes, phthalocyanine-based dyes, quinophthalone-based dyes, anthraquinone-based dyes, and methine-based dyes. Examples of the carbon material may include carbon black. Examples of the metal material may include gold, silver, and copper. Examples of the metal oxide may include titanium oxide, zinc oxide, zirconium oxide, barium titanate, potassium titanate, copper-chromium oxide, copper-manganese oxide, copper-iron-manganese oxide, copper-chromium-manganese oxide, and copper-iron-chromium oxide. Examples of the polymer material may include a polymer compound into which a functional group having a light absorption region in a visible light region is introduced. As long as the polymer compound has the light absorption region in the visible light region, the kind of the polymer compound is not specifically limited.

More specifically, for the migrating particles 32 that are used to perform display in a dark state, for example, the carbon material such as carbon black, or the metal oxide such as copper-chromium oxide, copper-manganese oxide, copper-iron-manganese oxide, copper-chromium-manganese oxide, or copper-iron-chromium oxide may be used. In particular, the carbon material may be preferably used for the migrating particles 32. The migrating particles 32 made of the carbon material exhibit high chemical stability, high mobility, and high light absorption.

The content (concentration) of the migrating particles 32 in the insulating liquid 31 may be, for example, but not specifically limited to, within a range of about 0.1 wt % to about 10 wt % both inclusive. In this concentration range, a shielding property and mobility of the migrating particles 32 are secured. More specifically, the content of the migrating particles 32 is smaller than about 0.1 wt %, the migrating particles 32 are less likely to shield (obscure) the porous layer 33, and it may be difficult to provide sufficient contrast. On the other hand, when the content of the migrating particles 32 is larger than about 10 wt %, dispersibility of the migrating particles 32 decreases and thus the migrating particles 32 are less likely to migrate, and the migrating particles 32 may be agglomerated.

It may be preferable that the migrating particles 32 be easily dispersed and charged in the insulating liquid 31 over a long time, and be less likely to be absorbed by the porous layer 33. Therefore, for example, a dispersant or a charge control agent may be added to the insulating liquid 31. Moreover, both of the dispersant and the charge control agent may be used.

The dispersant or the charge control agent may have, for example, one or both of a positive charge and a negative charge, and is used to increase a charge amount in the insulating liquid 31 and to disperse the migrating particles 32 by electrostatic repulsion. Examples of such a dispersant may include a Solsperse series manufactured by Lubrizol corp., a BYK series manufactured by BYK-Chemie, an OAS series and an Anti-Terra series manufactured by Chevron Chemical Co., and a Span series manufactured by ICI Americas Inc.

To improve dispersibility of the migrating particles 32, processing (surface treatment) may be subjected to surfaces of the migrating particles 32. Examples of the surface treatment may include rosin treatment, surfactant treatment, pigment derivative treatment, coupling agent treatment, graft polymerization treatment, and microencapsulation treatment. In particular, dispersion stability is allowed to be maintained for a long time by performing the graft polymerization treatment, the microencapsulation treatment, or a combination thereof.

For such surface treatment, for example, a material (a absorbent material) having a functional group that is absorbable on surfaces of the migrating particles 32 and a polymerizable functional group may be used. The absorbable functional group is determined depending on a formation material of the migrating particles 32. For example, in a case where the migrating particles 32 are made of a carbon material such as carbon black, an aniline derivative such as 4-vinyl aniline is allowed to be absorbed, and in a case where the migrating particles 32 are made of a metal oxide, an organosilane derivative such as 3-(trimethoxy cyril) propyl methacrylate is allowed to be absorbed. Examples of the polymerizable functional group may include a vinyl group, an acrylic group, and a methacryl group.

A polymerizable function group may be introduced into and grafted to the surfaces of the migrating particles 32 to perform surface treatment (a graft material). The graft material may include, for example, a polymerizable functional group and a dispersion functional group. The dispersion functional group allows the migrating particles 32 to be dispersed in the insulating liquid 31, and allows dispersibility to be maintained by steric hindrance thereof. For example, in a case where the insulating liquid 31 is paraffin, a branched alkyl group or the like may be used as the dispersion functional group. Examples of the polymerizable functional group may include a vinyl group, an acrylic group, and a methacryl group. For example, a polymerization initiator such as azobisisobutyronitrile (AIBN) may be used for polymerization and grafting of the graft material.

A method of dispersing the above-described migrating particles 32 in the insulating liquid 31 is described in detail in books such as “Dispersion Technique of Ultrafine Particles and Evaluation Thereof: Surface Treatment, Pulverizing, and Dispersion Stabilization in Gas, Liquid, and Polymer” published by Science & technology Co., Ltd.

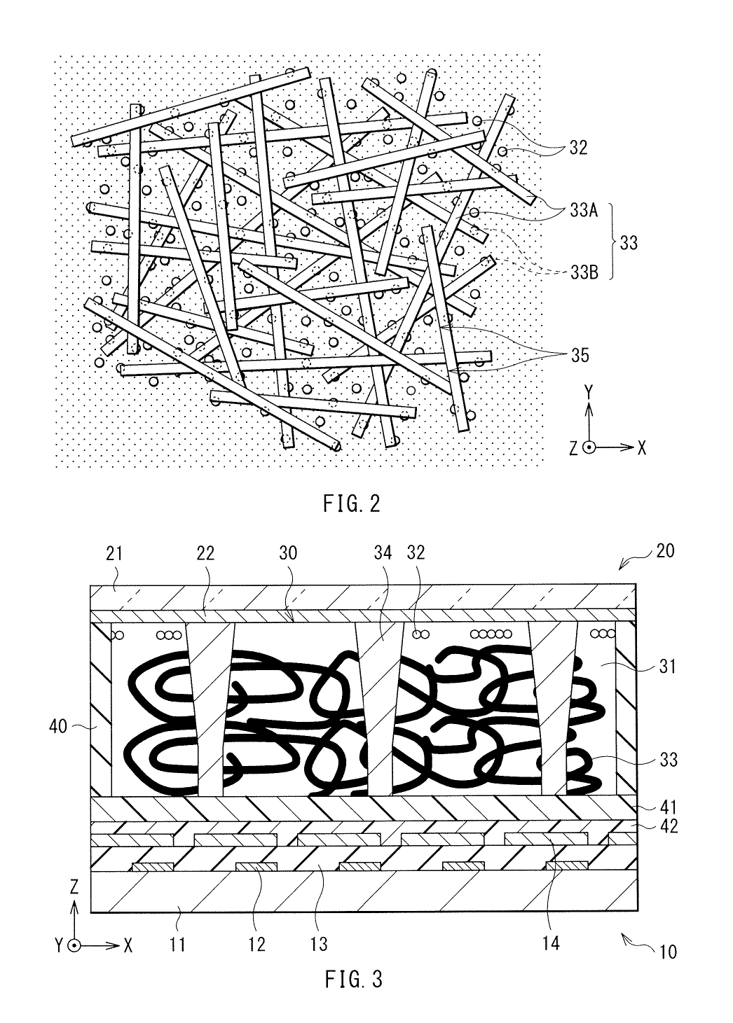

The porous layer 33 is capable of shielding the migrating particles 32. As illustrated in FIG. 2, the porous layer 33 includes a fibrous structure 33A and non-migrating particles 33B held by the fibrous structure 33A.

The porous layer 33 is a three-dimensional structure (an irregular network structure such as a nonwoven fabric) formed of the fibrous structure 33A, and has a plurality of openings (pores 35). When the three-dimensional structure of the porous layer 33 is configured of the fibrous structure 33A, a sufficiently large size of the pore 35 allowing the migrating particles 32 to move therethrough is allowed to be secured, and high contrast is allowed to be maintained in spite of the porous layer 33 with a small thickness. More specifically, light (outside light) is diffused (multiply scattered) by the three-dimensional structure of the porous layer 33 to cause an increase in light reflectivity of the porous layer 33. Therefore, even if the thickness of the porous layer 33 is small, high light reflectivity is obtainable. Moreover, when the fibrous structure 33A is used, the average pore diameter of the pore 35 is increased, and a large number of pores 35 are provided to the porous layer 33. Therefore, the migrating particles 32 easily move through the pores 35, the response speed is improved. Moreover, energy necessary to move the migrating particles 32 is further reduced. Such a porous layer 33 may have, for example, a thickness (in a Z direction) of about 5 μm to about 100 μm both inclusive.

The fibrous structure 33A is a fibrous material having a sufficient length with respect to a fiber diameter (a diameter). For example, a plurality of fibrous structures 33A may be gathered in a randomly overlapped manner to form the porous layer 33. One fibrous structure 33A may be randomly tangled to form the porous layer 33. Alternatively, the porous layer 33 configured of one fibrous structure 33A and the porous layer 33 configured of a plurality of fibrous structures 33A may be mixed. FIG. 2 illustrates the porous layer 33 configured of a plurality of fibrous structures 33A.

The fibrous structure 33A may be made of, for example, a polymer material or an inorganic material. Examples of the polymer material may include nylon, polylactic acid, polyamide, polyimide, polyethylene terephthalate, polyacrylonitrile, polyethylene oxide, polyvinyl carbazole, polyvinyl chloride, polyurethane, polystyrene, polyvinyl alcohol, polysulfone, polyvinylpyrrolidone, polyvinylidene fluoride, polyhexafluoropropylene, cellulose acetate, collagen, gelatin, chitosan, and copolymers thereof. Examples of the inorganic material may include titanium oxide. The polymer material may be preferably used for the fibrous structure 33A, because the polymer material has, for example, low reactivity with respect to light or the like and is chemically stable. In other words, unintentional decomposition of the fibrous structure 33A is allowed to be prevented by using the polymer material. In a case where the fibrous structure 33A is made of a highly reactive material, a surface of the fibrous structure 33A may be preferably covered with an arbitrary protective layer.

For example, the fibrous structure 33A may extend linearly. The fibrous structure 33A may have any shape, for example, may be curled, or bent at some point. Alternatively, the fibrous structure 33A may be branched at some point, or undulated. When the undulated fibrous structures 33A are tangled with one another, the configuration of the porous layer 33 is complicated and thus optical characteristics are allowed to be improved.

An average fiber diameter of the fibrous structure 33A may be, for example, within a range of about 1 nm to about 10000 nm both inclusive, and may be preferably within a range of about 1 nm to 100 nm both inclusive. A method of forming a porous layer made of cellulose, velvet, or the like has been proposed (refer to Japanese Examined Patent Application Publication No. S50-15120). However, refractive indices of cellulose and velvet are close to that of the insulating liquid; therefore, contrast may be reduced. Moreover, the fiber diameters of cellulose and velvet are as large as about 10 μm to about 100 μm both inclusive. On the other hand, when the average fiber diameter is reduced as described above, light is easily diffused, and the diameter of the pore 35 is increased. The fiber diameter is so determined as to allow the fibrous structure 33A to hold the non-migrating particles 33B. The average fiber diameter is allowed to be measured by microscopic observation with use of a scanning electron microscope or the like. The average length of the fibrous structure 33A is arbitrarily set. The fibrous structure 33A may be formed by, for example, a phase separation method, a phase inversion method, an electrostatic (electric field) spinning method, a melt spinning method, a wet spinning method, a dry spinning method, a gel spinning method, a sol-gel method, or a spray coating method. When such a method is used, the fibrous structure 33A with a sufficient length with respect to the fiber diameter is allowed to be formed easily and stably.

The fibrous structure 33A may be preferably configured of nanofibers. In this case, the nanofibers have a fiber diameter of about 1 nm to about 100 nm both inclusive and a length that is 100 or more times as large as the fiber diameter; therefore, light is easily diffused, and light reflectivity of the porous layer 33 is allowed to be further improved. In other words, contrast of the electrophoresis device 30 is allowed to be improved. Moreover, in the fibrous structure 33A made of nanofibers, the ratio of the pores 35 in a unit volume is increased and thus the migrating particles 32 easily move through the pores 35. Therefore, energy necessary to move the migrating particles 32 is allowed to be reduced. The fibrous structure 33A made of nanofibers may be preferably formed by an electrostatic spinning method. When the electrostatic spinning method is used, the fibrous structure 33A with a small fiber diameter is allowed to be formed easily and stably.

The fibrous structure 33A with higher light reflectivity than that of the migrating particles 32 may be preferably used. By doing so, contrast by a difference in light reflectivity between the porous layer 33 and the migrating particles 32 is easily formed. In a case where the fibrous structure 33A does not substantially affect light reflectivity of the porous layer 33, i.e., in a case where light reflectivity of the porous layer 33 is determined by the non-migrating particles 33B, the fibrous structure 33A exhibiting light transparency (colorless and transparent) may be used in the insulating liquid 31.

The pores 35 are formed by a plurality of fibrous structures 33A overlapping one another or one tangled fibrous structure 33A. The pores 35 may preferably have a largest possible average diameter so as to allow the migrating particles 32 to easily move through the pores 35. The average diameter of the pore 35 may be, for example, within a range of about 0.1 μm to about 10 μm both inclusive.

The non-migrating particles 33B are fixed in the fibrous structure 33A, and are one or two or more particles that do not electrically migrate. The non-migrating particles 33B may be embedded in the fibrous structure 33A holding the non-migrating particles 33B, or may be exposed in part from the fibrous structure 33A.

The non-migrating particles 33B with light reflectivity different from that of the migrating particles 32, more specifically with higher light reflectivity than that of the migrating particles 32 are used. The non-migrating particles 33B may be made of a material similar to that described in the above-described migrating particles 32. More specifically, for the non-migrating particles 33B used to perform display in a bright state, a metal oxide such as titanium oxide, zinc oxide, zirconium oxide, barium titanate, or potassium titanate may be preferably used. The metal oxide allows the non-migrating particles 33B to obtain high chemical stability, high fixity, and high light reflectivity. The materials of the non-migrating particles 33B and the migrating particles 32 may be the same as each other or different from each other. The non-migrating particles 33B may be visually recognized, for example, as white or a color close to white.

The partition wall 34 is configured to partition a space where the migrating particles 32 are present in the insulating liquid 31 into regions (cells 36). The partition wall 34 so extends toward a direction (the Z direction) where the drive substrate 10 and the counter substrate 20 are laminated as to penetrate the porous layer 33. One side of the partition wall 34 is in contact with the seal layer 41, and the other side of the partition wall 34 is in contact with the counter electrode 22. Movement of the migrating particles 32 between the cells 36 is allowed to be prevented by such a partition wall 34. Therefore, display unevenness caused by diffusion or agglomeration of the migrating particles 32 is allowed to be suppressed, thereby improving image quality. The heights (in the Z direction) of the partition walls 34 may be preferably aligned with one another. When the partition walls 34 with a same height are provided, a distance (a gap) between the seal layer 41 and the counter electrode 22 is uniformly kept in an entire plane, and electric field strength is allowed to be uniformly maintained. Accordingly, variation in response speed is eliminated. The height of the partition wall 34 may be, for example, within a range of about 1 μm to about 100 μm both inclusive.

The partition wall 34 may be so provided as to form, for example, the cells 36 with a hexagonal shape (a honeycomb structure). The cells 36 may have any shape, for example, a rectangular shape. A plurality of cells 36 may be preferably arranged in a matrix form (a plurality of rows by a plurality of columns). A distance between the partition walls 34 adjacent to each other along one direction (a pitch of the partition wall 34) may be, for example, within a range of about 50 μm to about 500 μm both inclusive.

As described above, the partition wall 34 extends in the porous layer 33, and the partition wall 34 may preferably support the porous layer 33. Therefore, even if the display unit 1 is left in a state in which the display unit 1 lies sideways or in an inverted position for a long time, the position of the porous layer 33 in the insulating liquid 31 is less likely to move, and contrast characteristics are allowed to be stabilized. As used herein, the term “the position of the porous layer 33” refers to a positional relationship (a distance and the like) between the porous layer 33, and the pixel electrode 14 and the counter electrode 22.

The partition wall 34 may preferably include a light-transmissive material and contain a part of the porous layer 33. Herein, “contain a part of the porous layer 33” indicates that a part of the porous layer 33 is contained as it is inside the partition wall 34 while maintaining a state in which the non-migrating particles 33B are held by the fibrous structure 33A (the configuration of the porous layer 33 in itself).

The partition wall 34 may include, for example, a photosensitive resin material as the light-transmissive material. The partition wall 34 containing a part of the porous layer 33 is allowed to be formed easily and stably by using the photosensitive resin material. Examples of the photosensitive resin material may include a resin capable of being photo-patterned, such as photocrosslinking reaction type, photomodification type, photopolymerization reaction type, and photodecomposition reaction type photocurable resins. The partition wall 34 may be made of one kind of photosensitive resin material, or may include a plurality of kinds of photosensitive resin materials. For example, by using a chemically stable photoresist as the photosensitive resin material, the partition wall 34 is allowed to be prevented from affecting a migration phenomenon of the migrating particles 32. The photoresist may be of a negative type or a positive type. Any light source, for example, a semiconductor laser, an excimer laser, electron beams, ultraviolet rays, a metal halide lamp, a high-pressure mercury vapor lamp, or the like may be used to pattern a photosensitive resin.

The spacer 40 may be made of, for example, an insulating material such as a polymer material, and may be arranged in, for example, a grid pattern between the drive substrate 10 and the counter substrate 20. For example, a sealant including microparticles may be used for the spacer 40. The arrangement shape of the spacer 40 is not specifically limited; however, the spacer 40 may be preferably so arranged as not to interfere with movement of the migrating particles 32 and as to uniformly distribute the migrating particles 32. The thickness of the spacer 40 may be, for example, within a range of about 10 μm to about 100 μm both inclusive, and may be preferably as thin as possible. Thus, power consumption is allowed to be reduced.

The above-described seal layer 41 and the adhesive layer 42 are provided between the drive substrate 10 and the electrophoresis device 30. The adhesive layer 42 is configured to bond the drive substrate 10 and the electrophoresis device 30 (more specifically, the seal layer 41) together, and may be made of, for example, an acrylic-based resin or a urethane-based resin. A rubber-based adhesive sheet or the like may be used as the adhesive layer 42.

Such a display unit 1 may be manufactured by, for example, the following processes.

First, the counter substrate 20 including the counter electrode 22 is formed on one surface of the supporting member 21, and then the porous layer 33 is formed on the counter electrode 22. The counter electrode 22 may be formed with use of an existing method selected from various kinds of film formation methods. The porous layer 33 is formed by preparing a spinning solution, adding, for example, titanium oxide as the non-migrating particles 33B to the spinning solution, sufficiently stirring the spinning solution containing the titanium oxide, and performing an electrostatic spinning method with use of the spinning solution. Instead of the electrostatic spinning method, a phase separation method, a phase inversion method, a melt spinning method, a wet spinning method, a dry spinning method, a gel spinning method, a sol-gel method, a spray coating method, or the like may be used. The spinning solution may be prepared, for example, by dispersing or dissolving polyacrylonitrile as the fibrous structure 33A in N,N′-dimethylformamide.

It is to be noted that the spinning method may be preferably used to form the fibrous structure 33A. Although a method of forming a porous layer by making a hole in a polymer film with use of laser processing has been proposed (refer to Japanese Unexamined Patent Application Publication No. 2005-107146), in this method, only a large hole with a diameter of about 50 μm is formed, and it may be difficult to completely shield the migrating particles by the porous layer.

Next, a solution (for example, an ultraviolet curable resin) formed by dissolving the material of the partition wall 34 in an organic solvent or the like as necessary is prepared, and a surface of the counter electrode 22 is so coated with the solution as to fill the porous layer 33 with the solution. Next, a plate-like auxiliary member is placed on the ultraviolet curable resin. The auxiliary member is provided to control a coating thickness of the ultraviolet curable resin, and the height of the partition wall 34 is adjustable by using the auxiliary member. The auxiliary member may be made of, for example, a material similar to that of the supporting member 21, and has light transparency. The auxiliary member may have light reflectivity or light absorption. The ultraviolet curable resin may be, for example, a negative photoresist (UV resin). As the material of the partition wall 34, a photosensitive resin material other than the ultraviolet curable resin may be used.

After the auxiliary member is provided on the ultraviolet curable resin, light L is locally applied to the ultraviolet curable resin to perform patterning, thereby forming the partition wall 34. More specifically, the light L is applied to each of formation regions of the partition wall 34 to expose the ultraviolet curable resin in each of the formation regions to the light L. The light L at this time reaches the ultraviolet curable resin through the light-transmissive supporting member 21 or the auxiliary member. The light L may be, for example, laser light of an ultraviolet wavelength region. Since the laser light is used as the light L, a mask is not necessary, and a desired region is allowed to be easily and precisely exposed to the light L. Lamp light of an ultraviolet wavelength region may be applied with use of a mask. Laser light and lamp light may be used in combination.

The light L may be preferably applied from two directions, i.e., from the auxiliary member side and the supporting member 21 side that faces the auxiliary member. When the light L is applied to the ultraviolet curable resin from two directions, the strength of the partition wall 34 is allowed to be maintained, and contrast is allowed to be improved.

After the light L is applied, the auxiliary member is removed, and the ultraviolet curable resin exposed to the light L is developed. The developed ultraviolet curable resin may be heated as necessary. Thus, a portion that is not exposed to the light L of the ultraviolet curable resin is removed, and a remaining portion (a portion exposed to the light L) of the ultraviolet curable resin is formed into a film to form the partition wall 34 containing a part of the porous layer 33.

Next, the seal layer 41 is formed on a peeling member. For the seal layer 41, a solution is formed by mixing, for example, thermoplastic polyurethane, methyl ethyl ketone (MEK), and cyclohexanone at a predetermined ratio and then completely dissolving them. After the peeling member is coated with the solution, and the solution is heated and dried to form the seal layer 41. Next, the porous layer 33 on the counter substrate 20 is coated with the insulating liquid 31 in which the migrating particles 32 are dispersed, and then the counter substrate 20 and the peeling member including the seal layer 41 are so arranged as to face each other, and then are bonded together by pressure. After that, the seal layer 41 is peeled from the peeling member to be fixed to the drive substrate 10 with the adhesive layer 42. In the drive substrate 10, the TFTs 12, the protective layer 13, and the pixel electrodes 14 are formed in this order on one surface of the supporting member 11 with use of, for example, an existing method. Thus, the display unit 1 is completed by the above processes. The display unit 1 may be manufactured with use of a roll-to-roll method.

In an initial state of the display unit 1, all of the migrating particles 32 dispersed in the insulating liquid 31 are located on a side closer to the pixel electrodes 14 (refer to FIG. 1). At this time, when the electrophoresis device 30 is viewed from the counter substrate 20, the migrating particles 32 are shielded by the porous layer 33, and an image is not displayed.

When pixels are selected by the TFTs 12, and an electric field is applied between the pixel electrodes 14 and the counter electrode 22, as illustrated in FIG. 3, in the selected pixels, the migrating particles 32 move toward the counter electrode 22 through the pores 35 of the porous layer 33. At this time, when the electrophoresis device 30 is viewed from the counter substrate 20, pixels for display in a dark state in which the migrating particles 32 are shielded by the porous layer 33 and pixels for display in a bright state in which the migrating particles 32 are not shielded by the porous layer 33 coexist. Contrast is caused by the pixels for display in the dark state and the pixels for display in the bright state to display an image on the counter substrate 20.

In this case, when an additive is added to the seal layer 41 configured to seal the electrophoresis device 30 configuring the display unit 1, the surface properties of the seal layer 41 are improved. More specifically, for example, one or a combination of the anionic surfactant and the nonionic surfactant that have an acid structure (for example, carboxylate or an ester bond) in a molecule may be added as an additive to, for example, a thermoplastic urethane resin as a base material. Therefore, for example, the acid structure is provided on a surface of the seal layer 41, thereby reducing affinity of the migrating particles 32 for the seal layer 41.

As described above, in the display unit 1 according to this embodiment, the additive is added to the seal layer 41 in contact with the electrophoresis device 30; therefore, the surface properties of the seal layer 41 are improved. More specifically, when, for example, the surfactant having an acid structure in a molecule is used as an additive, the acid structure is provided on the surface of the seal layer 41, and affinity of the migrating particles 32 for the seal layer 41 is reduced, thereby improving display characteristics (for example, response speed and reflectivity).

Moreover, addition of the additive to the seal layer 41 reduces volume resistance of the seal layer 41. Therefore, response speed is further improved, and power consumption is reduced.

Further, when the addition amount of the additive to the seal layer 41 is within a range of about 0.01 wt % to about 10 wt % both inclusive, response speed is allowed to be improved while maintaining memory properties that is traded off for response speed.

### 2. Modification Example

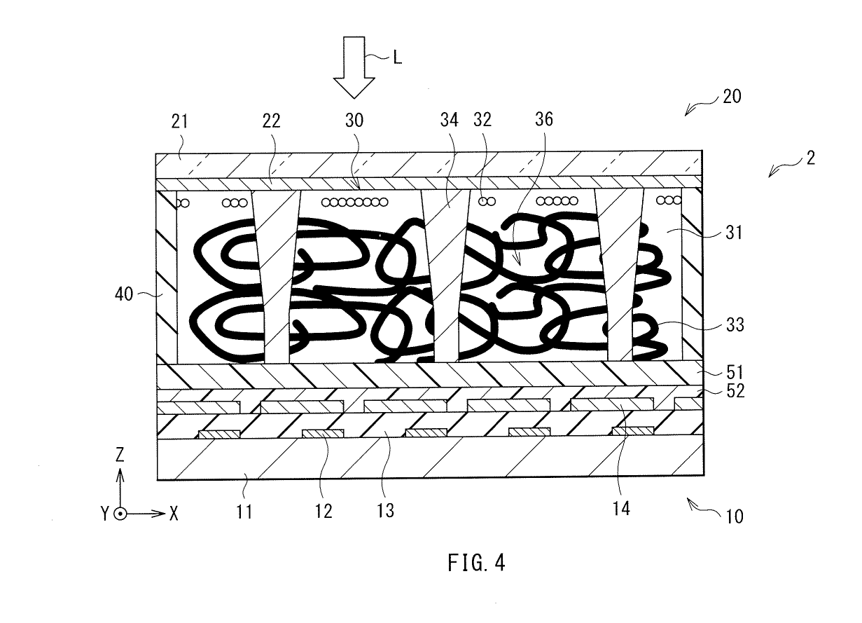

FIG. 4 illustrates a sectional configuration of a display unit (a display unit 2) according to a modification example of the above-described embodiment. The display unit 2 includes the electrophoresis device 30 between the drive substrate 10 and the counter substrate 20, and the electrophoresis device 30 is disposed on the counter substrate 20, and has a configuration sealed by a seal layer 51. This modification example differs from the above-described embodiment in that the seal layer 51 is dyed.

As with the above-described seal layer 41, the seal layer 51 may use, for example, a thermoplastic resin as a base material, and an additive that suppresses absorption of the migrating particles 32 to a surface of the seal layer 51 is added to the thermoplastic resin. This additive is the additive described in the first embodiment, and, for example, an additive having an acid structure in a molecule may be preferably used. Specific examples of the additive may include a surfactant having an average molecular weight of about 100 to about 100000 both inclusive and a dispersant having an average molecular weight of about 100 to about 100000 both inclusive. As described above, examples of the surfactant may include an anionic surfactant having an acid structure in a molecule and a nonionic surfactant having an acid structure in a molecule, and surface properties of the seal layer 51 may be improved by using one or a combination of the anionic surfactant and the nonionic surfactant.

In this modification example, a colorant is added to the seal layer 51 in addition to the base material and the additive. Examples of the colorant of the seal layer 51 may include a colorant of white or a color close to white and a colorant of black or a color close to black. It is to be noted that, in the display unit 2 as with this modification example, while reflectivity of the display body increases with an increase in reflectivity of the seal layer 51, the seal layer 51 itself reflects light; therefore, there is a possibility that contrast of the electrophoresis device 30 is reduced. On the other hand, black reflectivity of the display body is improved more with an increase in absorptance of the seal layer 51, thereby improving contrast of the electrophoresis device 30. Therefore, the seal layer 51 may be preferably dyed in black or a color close to black. As the colorant, the particles (powder) or the like of the organic pigment, the inorganic pigment, the dye, the carbon material, the metal material, the metal oxide, glass, the polymer material (resin), or the like that configure the migrating particles and are described in the above-described first embodiment may be used. For example, in a case where the seal layer 51 is dyed in black, a carbon material such as carbon black may be preferably used.

Thus, in this modification example, in addition to the effects in the above-described embodiment, the reflectivity of the display body (the electrophoresis device 30) is allowed to be controlled by adding the colorant to the seal layer 51 formed by addition of the additive to dye the seal layer 51, and an effect that contrast is allowed to be improved is achieved. Therefore, display characteristics of the display unit 2 is allowed to be further improved.

Moreover, in this modification example, the colorant is added to the seal layer 51; however, even if the colorant is added to, for example, an adhesive layer 52 to dye the adhesive layer 52, effects similar to those in this modification example are obtainable.

It is to be noted that the colorant may be added to not only the seal layer 51 (or the adhesive layer 52) but also the partition wall 34. Even in a case where the colorant is added to the partition wall 34, as with the above-described seal layer 51, the partition wall 34 may be preferably dyed in black or a color close to black. Therefore, contrast of the display body is allowed to be improved, and the display characteristics of the display unit 2 are allowed to be further improved.

### 3. Application Examples

Next, application examples of the above-described display units 1 and 2 will be described below. The display units 1 and 2 are allowed to be mounted in the following electronic apparatuses; however, the configurations of the electronic apparatuses that will be described below are merely examples, and may be modified as appropriate.

### Application Example 1

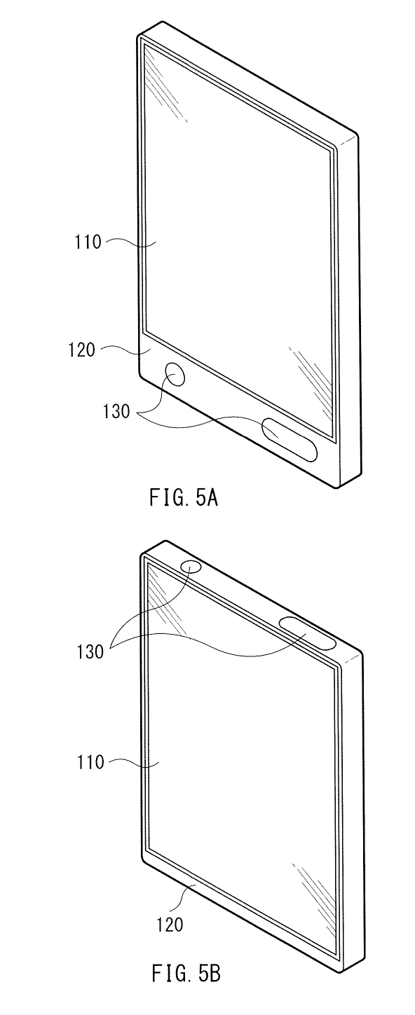

FIGS. 5A and 5B illustrate an appearance of an electronic book. The electronic book may include, for example, a display section 110, a non-display section 120, and an operation section 130. It is to be noted that the operation section 130 may be disposed on a front surface of the non-display section 120 as illustrated in FIG. 5A or may be disposed on a top surface of the non-display section 120 as illustrated in FIG. 5B. The display section 110 is configured of the display unit 1 (or the display unit 2). It is to be noted that the display unit 1 (or the display unit 2) may be mounted in a PDA (Personal Digital Assistants) with a configuration similar to that of the electronic book illustrated in FIGS. 5A and 5B.

### Application Example 2

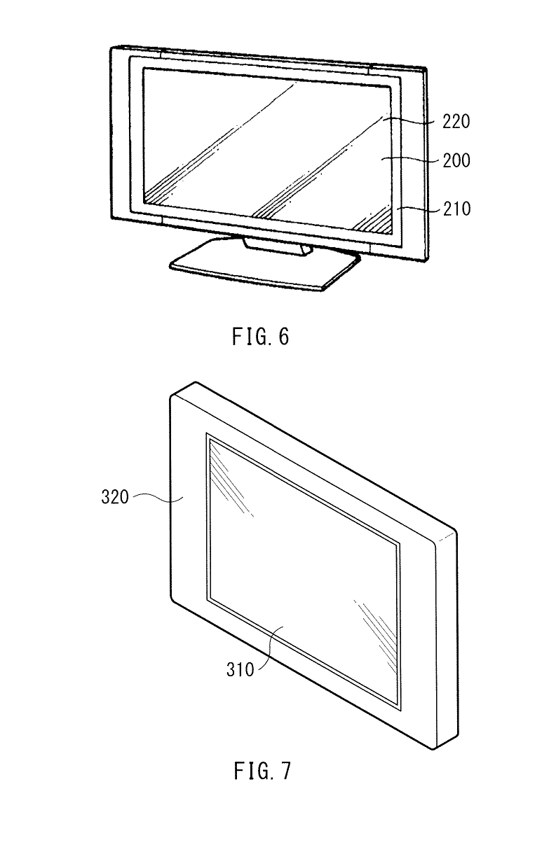

FIG. 6 illustrates an appearance of a television. The television may include, for example, an image display screen section 200 including a front panel 210 and a filter glass 220. The image display screen section 200 is configured of the display unit 1 (or the display unit 2).

### Application Example 3

FIG. 7 illustrates an appearance of a tablet personal computer. The tablet personal computer may include, for example, a touch panel section 310 and an enclosure 320, and the touch panel section 310 is configured of the display unit 1 (or the display unit 2).

### Application Example 4

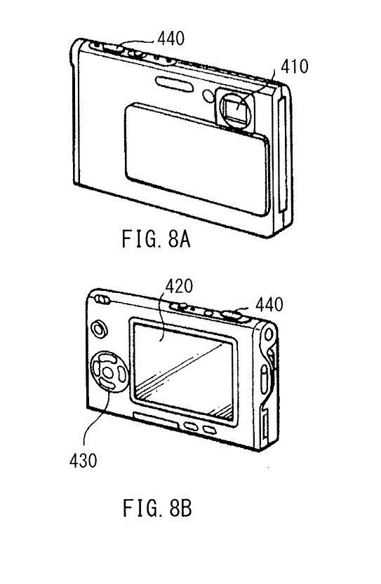

FIGS. 8A and 8B illustrate an appearance of a digital still camera. FIG. 8A illustrates a front surface, and FIG. 8B illustrates a back surface. The digital still camera may include, for example, a light-emitting section 410 for a flash, a display section 420, a menu switch 430, and a shutter button 440. The display section 420 is configured of the display unit 1 (or the display unit 2).

### Application Example 5

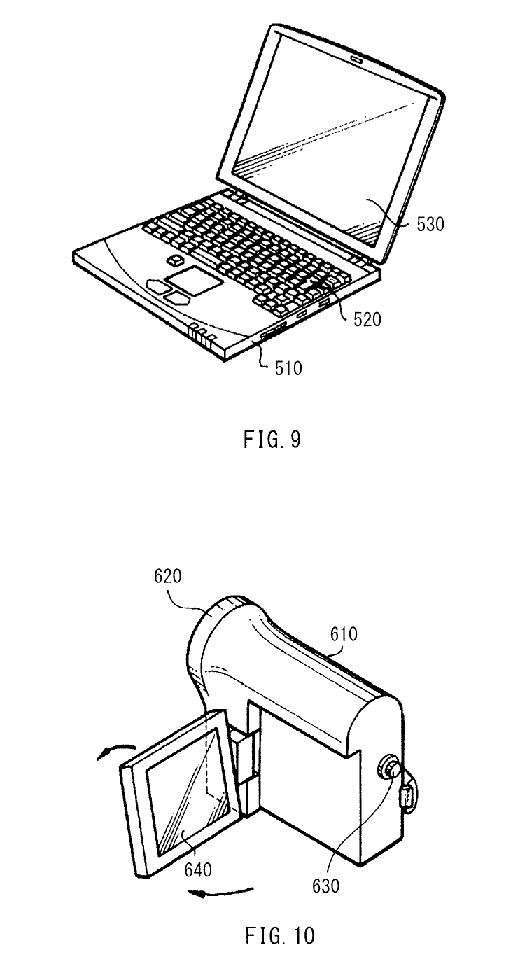

FIG. 9 illustrates an appearance of a notebook personal computer. The notebook personal computer may include, for example, a main body 510, a keyboard 520 for operation of inputting characters and the like, and a display section 530 for displaying of an image. The display section 530 is configured of the display unit 1 (or the display unit 2).

### Application Example 6)

FIG. 10 illustrates an appearance of a video camera. The video camera may include, for example, a main section 610, a lens 620 provided on a front surface of the main section 610 and for shooting of an image of an object, a shooting start/stop switch 630, and a display section 640. The display section 640 is configured of the display unit 1 (or the display unit 2).

### Application Example 7

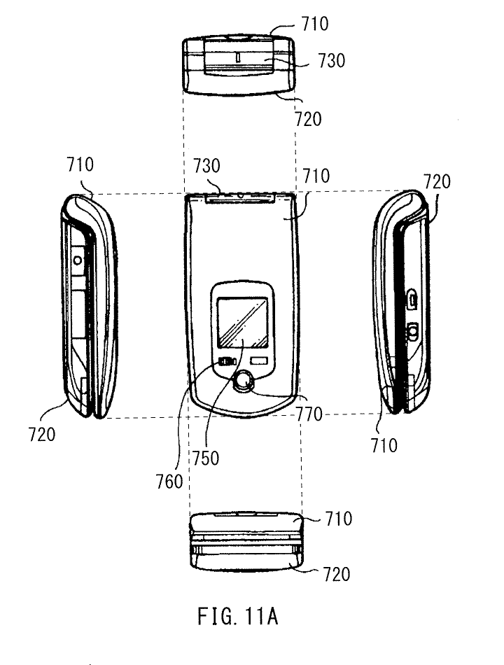

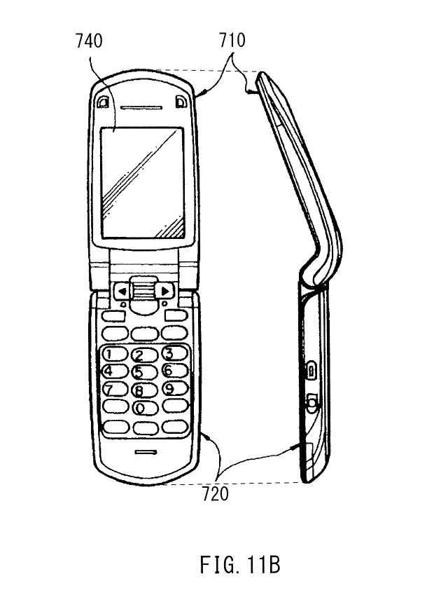

FIGS. 11A and 11B illustrate an appearance of a cellular phone. FIG. 11A illustrates a front surface, a left side surface, a right side surface, a top surface, and a bottom surface in a state in which the cellular phone is closed. FIG. 11B is a front surface and a side surface in a state in which the cellular phone is opened. The cellular phone may be configured by connecting, for example, a top-side enclosure 710 and a bottom-side enclosure 720 to each other by a connection section (hinge section) 730, and the cellular phone may include a display 740, a sub-display 750, a picture light 760, and a camera 770. The display 740 or the sub-display 750 is configured of the display unit 1 (or the display unit 2).

### 4. Examples

Next, examples of an embodiment of the present technology will be described below.

### Example 1

The display unit 1 (Experimental Examples 1-1 to 1-7) was fabricated by the following procedure, and response speed of the display unit 1 was measured.

### (Preparation of Migrating Particles)

First, 10 g of carbon black (#40 manufactured by Mitsubishi Chemical Corporation) was added to 1 liter of water, and the water to which carbon black was added was stirred, and then 1 ml of hydrochloric acid (37 wt %) and 0.2 g of 4-vinylaniline were added to a resultant solution to prepare a solution A. Then, 0.3 g of sodium nitrite was dissolved in 10 ml of water, and a resultant solution was heated to 40° C. to prepare a solution B. Next, a reaction was caused by gradually adding the solution B to the solution A and stirring a resultant solution for 10 hours, and then centrifugal separation was performed on the resultant solution to obtain a solid product. After the product was cleaned with water, and then was cleaned with acetone while performing centrifugal separation, the product was dried in a vacuum dryer (at 50° C.).

Next, 5 g of the product, 100 ml of toluene, 15 ml of 2-ethylhexyl methacrylate, and 0.2 g of AIBN were put into a reaction flask equipped with a nitrogen purging system, an electromagnetic stir rod, and a reflux column, the reaction flask was purged with nitrogen for 30 minutes under stirring. Then, a resultant mixture in the reaction flask was stirred in a hot water bath at 80° C. for 10 hours. Next, after a product was centrifugally separated, and centrifugal separation was performed three times with addition of tetrahydrofuran (THF) and ethyl acetate to clean the product, the product was dried in a vacuum dryer (at 50° C.). As a result, 4.7 g of polymer-coated carbon black was obtained as black migrating particles 32.

### (Preparation of Insulating Liquid)

Next, an insulating liquid was prepared by mixing 10 wt % of N,N-dimethylpropane-1,3-diamine, 10 wt % of 12-hydroxyoctadecanoic acid, 10 wt % of methoxysulfonyloxymethane (Solsperse 17000 manufactured by Lubrizol Ltd.), 5.0% of sorbitan trioleate (Span85), and 94% of isoparaffin (IsoparG manufactured by Exxon Mobil Corporation) as a first component. In this case, 0.1 g of migrating particles were added to 9.9 g of the insulating liquid as necessary, and a resultant solution was stirred for 5 minutes in a bead mill, and then beads were removed from the resultant solution to prepare an insulating liquid in which the migrating particles 32 were dispersed. It is to be noted that the insulating liquid may be prepared by adding succinimide (OAS1200 manufactured by Chevron Chemical Co.) in addition to the above-described materials.

### (Preparation of Porous Layer)

Next, as a formation material of the fibrous structure, 12 g of polyacrylonitrile (manufactured by Aldrich; with a molecular weight of 150000) was dissolved in 88 g of N,N′-dimethylformamide to prepare a spinning solution (a solution C). Next, after, for example, 30 g of titanium oxide (TITONE R-42 manufactured by Sakai Chemical Industry Co., Ltd.) was added as the non-migrating particles 32 to 70 g of the solution C, and a resultant solution was mixed in a bead mill to prepare a spinning solution (a solution D). Then, the spinning solution D was put into a syringe, and with use of an electrospinning machine (NANON manufactured by MECC Co., Ltd.), spinning corresponding to eight reciprocal motions was performed on a PET substrate where pixel electrodes (ITO) with a predetermined pattern shape were formed (the fibrous structure 33A). As spinning conditions in this case, electric field strength was 28 kV, a discharge rate was 0.5 cm³/min, a spinning distance was 15 cm, and a scanning rate was 20 mm/sec. Next, the PET substrate was put into a vacuum oven (at 75° C.) for 12 hours to dry the fibrous structure 33A including the non-migrating particles 33B, thereby forming the porous layer 33. It is to be noted that the fibrous structure 33A may be formed with use of poly(methyl methacrylate) (manufactured by Aldrich; with a molecular weight of 996000) as the formation material.

### (Assembly of Display Unit)

Next, after the partition wall 34 was formed with use of the above-described method, the seal layer 41 was formed on a peeling substrate. First, 1 g of pellets of thermoplastic polyurethane (E780M128 manufactured by Nippon Miractran Co, Ltd.) was mixed with MEK and cyclohexanone at a ratio of 1:4:2, and then 0.01 g (1 wt % with respect to a polyurethane base solvent) of a nonionic additive (MALIALIM AKM-0531 manufactured by NOF Corporation) was added to a resultant mixture, and the resultant mixture was stirred for 8 hours in a roll mill to completely solve the nonionic additive, thereby preparing a solution E. A PET separator was coated with the solution E with use of an applicator with a slit width of 120 μm, and then the solution E was dried at 90° C. for 5 hours on a hot plate to obtain the seal layer 41 with a sheet shape (with a thickness of 10 μm).

Next, the porous layer 33 on the PET substrate was coated with the insulating liquid 31, and then a front surface provided with the porous layer 33 of the PET substrate and the seal layer 41 were arranged to face each other, and were bonded together by thermocompression bonding with use of a laminator heated at 110° C. It is to be noted that, in this case, sealing of the PET substrate (more specifically, the electrophoresis device 30) by the seal layer 41 was performed by thermocompression bonding by the laminator; however, the bonding method is not limited thereto, and, for example, a method of performing curing by application of ultraviolet rays or the like may be used. Next, the peeling substrate was peeled from the seal layer 41, and then the drive substrate 10 including the TFTs 12 and the like was bonded to the seal layer 41 with the adhesive layer 42 in between to fabricate the display unit 1 (Experimental Example 1-1).

Experimental Examples 1-2 to 1-7 in which the kind, the addition amount, and the like of the additive were changed were fabricated, and response speeds of Experimental Examples 1-2 to 1-7 were measured. Table 1 illustrates the configurations of Experimental Examples 1-1 to 1-7 and measurement results of response speeds of Experimental Examples 1-1 to 1-7. The response speed is time taken to change (fall) luminance from 0.9 to 0.1 after application of an electric field, where luminance in a white state is 1 and luminance in a black state is 0. It is to be noted that a function generator (manufactured by Toyo Corporation) was used for measurement of response speed. Moreover, Experimental Example 1-4 was configured without the seal layer, and Experimental Example 1-5 was configured with use of a typical seal layer (including only a base material (thermoplastic polyurethane; E780M128)).

TABLE 1

| | Additive | | | | | Response |
|---|---|---|---|---|---|---|
| | | | | | Addition | Speed |
| | | | | Acid | Amount | (Fall) |
| | Material | Property | HLB Value | Structure | (wt %) | msec |
| Experimental | AKM- | Nonionic | Hydrophilic | Included | 1 | 480 |
| Example 1-1 | 0531 | | | | | |
| Experimental | NF-13 | Anionic | Hydrophilic | Included | 1 | 290 |
| Example 1-2 | | | | | | |
| Experimental | AKM- | Nonionic | Hydrophilic | Included | 3 | 300 |
| Example 1-3 | 0531 | | | | | |
| | NF-13 | Anionic | Hydrophilic | Included | 0.5 | |
| Experimental | — | — | — | — | — | 300 |
| Example 1-4 | | | | | | |
| Experimental | — | — | — | — | — | 720 |
| Example 1-5 | | | | | | |
| Experimental | OT221 | Nonionic | Hydrophilic | Not | 1 | 820 |
| Example 1-6 | | | (15.7) | Included | | |
| Experimental | AFB | Nonionic | Hydrophobic | Included | 1 | 700 |
| Example 1-7 | 1521 | | | | | |

As can be seen from Table 1, the display units (Experimental Examples 1-1 to 1-3) in which the seal layer 41 was formed with the addition of the additive, compared to the display unit (Experimental Example 1-5) using the typical seal layer, the response speed was remarkably improved. Moreover, it was found that the additive to the base material (thermoplastic urethane) configuring the seal layer 41 was preferably hydrophilic and preferably had an acid structure. It is to be noted that the display unit (Experimental Example 1-4) fabricated without forming the seal layer had high response speed; however, peeling between the drive substrate and the counter substrate occurred immediately.

### Example 2

The display unit 1 (Experimental Example 2-1) in which the addition amount of the nonionic surfactant (MALIALIM AKM-0531 manufactured by NOF Corporation) as the additive was changed from 0.1 wt % to 30 wt % both inclusive was fabricated with use of a similar method, and response speeds with respect to respective addition amounts and reflectivity (a simple memory property) with respect to respective addition amounts after one minute from when display in a bright (or dark) state was performed by application of a voltage of 15 V and then the application of the voltage stops were measured. Moreover, the display unit 1 (Experimental Example 2-2) using the anionic surfactant (HITENOL NF-13 manufactured by Dai-Ichi Kogyo Seiyaku Co., Ltd.) and the display unit 1 (Experimental Example 2-3) using a combination of the above-described nonionic surfactant and the above-described anionic surfactant were fabricated, and the response speeds and reflectivity after one minute with respect to respective addition amounts were measured.

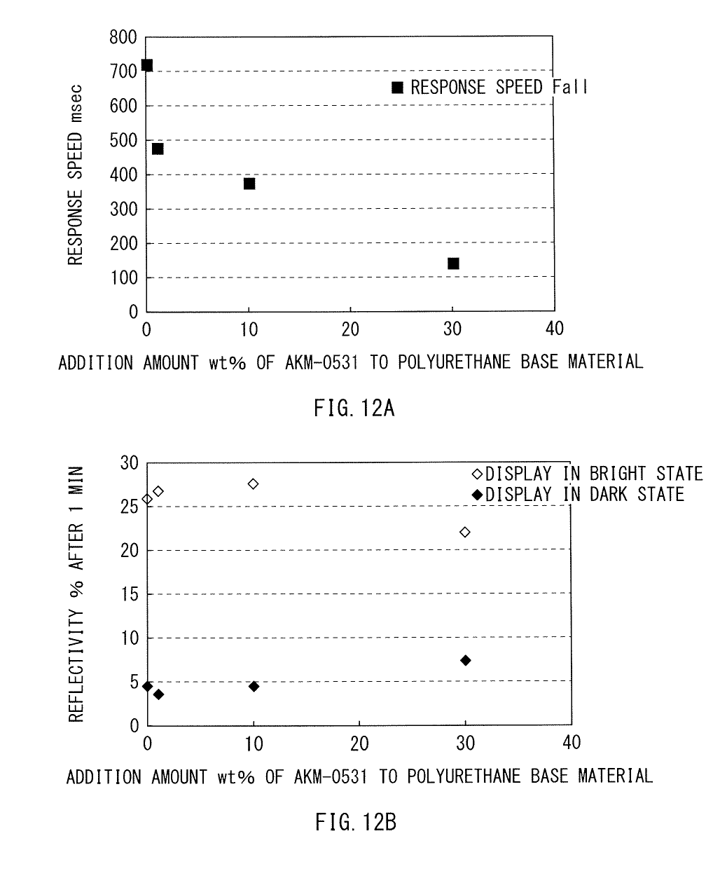

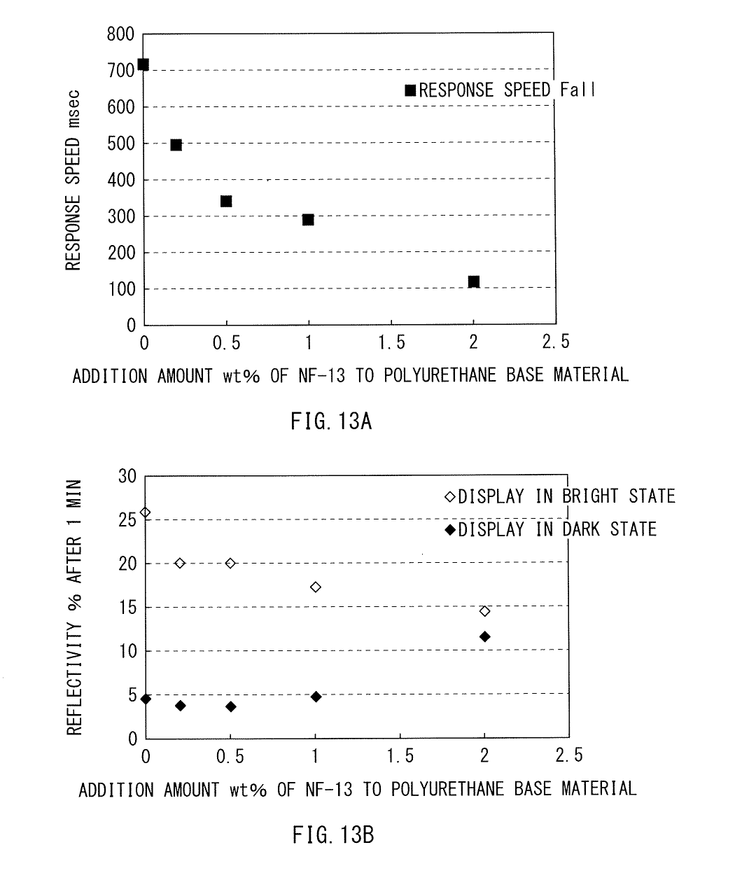

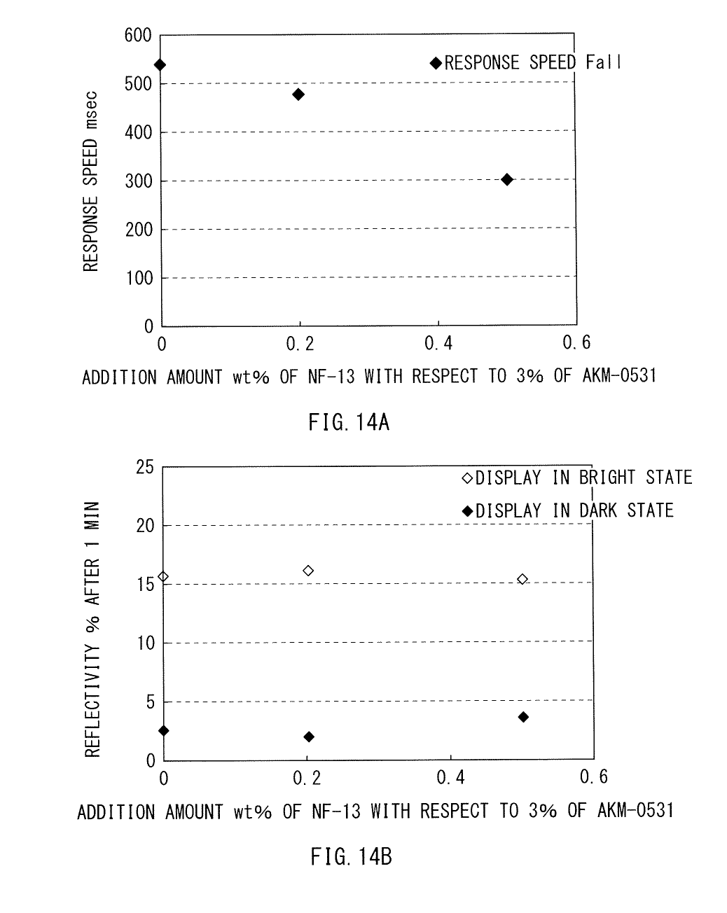

FIGS. 12A and 12B illustrate the response speed (FIG. 12A) and reflectivity after one minute from display in a bright state and display in a dark state (FIG. 12B) in Experimental Example 2-1. FIGS. 13A and 13B illustrate the response speed (FIG. 13A) and reflectivity after one minute from display in a bright state and display in a dark state (FIG. 13B) in Experimental Example 2-2. FIGS. 14A and 14B illustrate the response speed (FIG. 14A) and reflectivity after one minute from display in a bright state and display in a dark state (FIG. 14B) in Experimental Example 2-3. The response speed in this case is time taken to change luminance from 0.9 to 0.1 when an electric field is applied.

As can be seen from FIGS. 12A and 13A, the response speed was improved with a smaller addition amount of the anionic surfactant than that of the nonionic surfactant. Therefore, it was found that the response speed of the display unit 1 was improved by adding the additive within a range of about 0.01 wt % to about 10 wt % both inclusive. It is to be noted that a sufficient improvement in response speed was observed at an addition amount of 5 wt %. However, as can be seen from FIGS. 12B and 13B, in Experimental Example 2-1 using the nonionic surfactant as the additive, a change in the memory property by an increase in addition amount was hardly observed, but in Experimental Example 2-2 using the anionic surfactant, reflectivity was gradually reduced with an increase in addition amount. Therefore, it is found that, specifically in a case where the anionic surfactant is used, when the addition amount is within a range of about 0.01 wt % to about 2 wt % both inclusive, response speed is allowed to be improved while maintaining the memory property. Moreover, as can be seen from FIGS. 14A and 14B, in Experimental Example 2-3 in which a combination of the nonionic surfactant and the anionic surfactant was used as the additive, maintenance of reflectivity (memory ratio) and an improvement in response speed were both achievable with a smaller addition amount, compared to a case where the nonionic surfactant or the anionic surfactant was used alone.

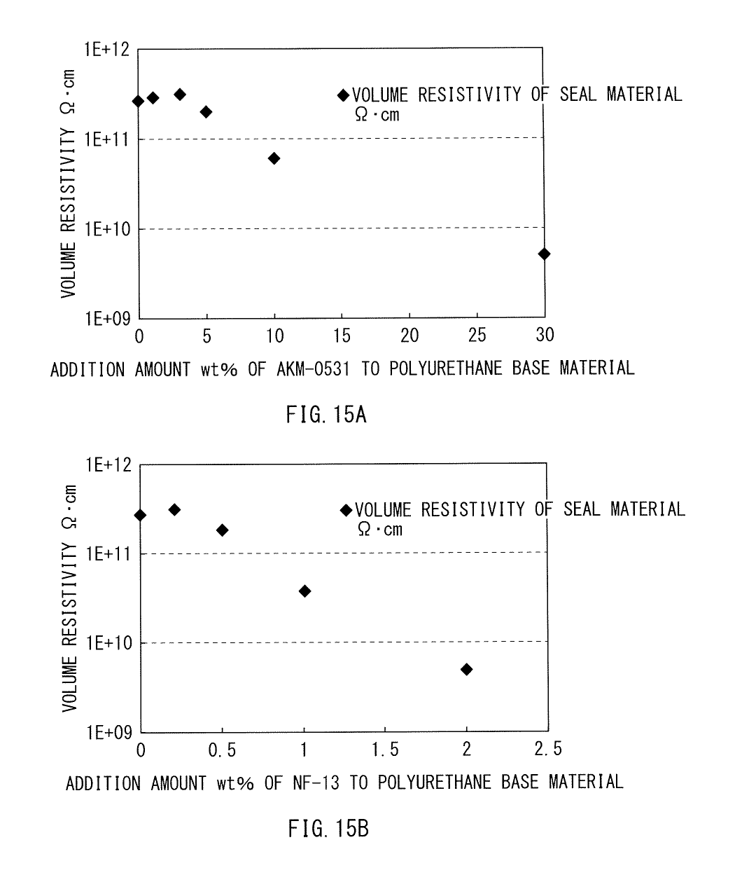

Moreover, FIGS. 15A and 15B illustrate a relationship between the addition amount of the additive and volume resistivity of the seal layer 41 in Experimental Examples 2-1 and 2-2. As can be seen from FIGS. 15A and 15B, although volume resistivity was reduced by adding the additive to the seal layer 41, a rate of the change was not large within this range of the addition amount (for example, 10 wt % or less in FIG. 13B). In other words, it is found that functions and effects in the embodiment of the present disclosure are not caused by a reduction in voltage drop in the seal layer 41 by a reduction in volume resistivity of the base material configuring the seal layer 41.

### Example 3

In this example, the display unit 2 in which a partition wall width was 16 μm, a pitch of the partition wall was 160 μm, and the seal layer 51 and the partition wall 34 were dyed by adding a colorant to them was assumed, and changes in reflectivity and contrast of the display unit 2 were simulated. Characteristics of the seal layer 51 and the partition wall 34 were changed within a range of +90 to −95 both inclusive. Tables 2, 3 and 4 illustrate values of white reflectivity, black reflectivity, and contrast of the display unit 2, respectively, when the characteristics of the seal layer 41 and the partition wall 34 were changed within a range of +90 to −95. It is to be noted that a characteristic “+” indicates reflection and a characteristic “−” indicates absorption, and respective columns indicated by “0” of respective characteristics indicate the display unit 2 configured without adding the colorant to the seal layer 51 and the partition wall 34.

TABLE 2

| | | Characteristic of Seal Layer | | | | |
|---|---|---|---|---|---|---|
| White Reflectivity | | +90 | +53 | 0 | −49 | −95 |
| Characteristic | +90 | 36.9 | 36.9 | 37.0 | 36.7 | 36.6 |
| of Partition | 0 | 34.2 | 29.0 | 20.3 | 19.9 | 18.9 |
| Wall | −95 | 18.7 | 18.4 | 17.4 | 17.3 | 16.8 |

TABLE 3

| | | Characteristic of Seal Layer | | | | |
|---|---|---|---|---|---|---|
| Black Reflectivity | | +90 | +53 | 0 | −49 | −95 |
| Characteristic | +90 | 10.6 | 10.7 | 10.7 | 10.3 | 9.8 |
| of Partition | 0 | 9.9 | 8.6 | 2.3 | 1.7 | 0.8 |
| Wall | −95 | 2.1 | 2.2 | 1.4 | 1.2 | 0.7 |

TABLE 4

| | | Characteristic of Seal Layer | | | | |
|---|---|---|---|---|---|---|
| Contrast | | +90 | +53 | 0 | −49 | −95 |
| Characteristic | +90 | 3.5 | 3.5 | 3.5 | 3.6 | 3.7 |
| of Partition | 0 | 3.5 | 3.4 | 8.7 | 11.6 | 24.4 |
| Wall | −95 | 9.0 | 8.5 | 12.1 | 14.6 | 24.6 |

As can be seen from Table 2, white reflectivity was improved by enhancing reflection characteristics of the seal layer 51 and the partition wall 34, i.e., by dying the seal layer 51 and the partition wall 34 in white. Moreover, as can be seen from Table 3, black reflectivity was improved by enhancing absorption characteristics of the seal layer 51 and the partition wall 34, i.e. by dying the seal layer 51 and the partition wall 34 in black. As can be seen from these results, reflectivity is allowed to be improved arbitrarily by adding a suitable colorant to the seal layer 51 and the partition wall 34. Further, as can be seen from Table 4, contrast of the display unit 2 was remarkably improved by specifically enhancing the absorption characteristic of the seal layer 51, i.e., by dying the seal layer 51 in black.

Although the present technology is described referring to the embodiments, the modification examples, and the examples, the present technology is not limited thereto, and may be variously modified. For example, in the above-described embodiments and the like, a case where display in a dark state is performed by the migrating particles and display in a bright state is performed by the porous layer is described; however, display in the dark state may be displayed by the porous layer, and display in the bright state may be displayed by the migrating particles.

Moreover, in the above-described embodiments and the like, a case where the drive substrate 10 and the seal layer 41 are fixed with the adhesive layer 42 in between; however, the seal layer 41 may be directly fixed to the drive substrate 10.

Further, in the above-described embodiments and the like, a method of coating the counter substrate 20 where the porous layer 33 is formed with the insulating liquid 31, and then arranging the counter substrate 20 to face the seal layer 16 is described; however, the display unit 1 may be manufactured by any other method. For example, after the drive substrate 10 and the seal layer 41 are arranged to face each other, the insulating liquid 31 may be charged into a portion between the drive substrate 10 and the seal layer 41.

Furthermore, in the above-described embodiments and the like, the electrophoresis device is used as the display body; however, the present technology is not limited thereto, and may be applicable to, for example, a display unit using a liquid optical device. The liquid optical device may be, for example, a so-called electrowetting device including a non-polar liquid and a polar liquid.

It is to be noted that the effects described in this description are merely examples; therefore, effects in the present technology is not limited thereto, and the present technology may have other effects.

It is to be noted that the present technology may have the following configurations.

(1) A display unit including:

a first substrate;

a second substrate facing the first substrate;

a display layer provided between the first substrate and the second substrate and allowed to control light transmission or light reflection; and

a seal layer including an additive and provided between the first substrate and the display layer.

(2) The display unit according to (1), in which the additive has one or more kinds of acid structures.

(3) The display unit according to (1) or (2), in which an average molecular weight of the additive is within a range of about 100 to about 100000 both inclusive.

(4) The display unit according to any one of (1) to (3), in which the additive is an anionic surfactant.

(5) The display unit according to any one of (1) to (4), in which the additive is a nonionic surfactant.

(6) The display unit according to any one of (1) to (5), in which the additive is a mixture of an anionic surfactant and a nonionic surfactant.

(7) The display unit according to any one of (1) to (6), in which an HLB value of the additive is about 10 or more.

(8) The display unit according to any one of (1) to (7), in which an addition amount of the additive is about 10 wt % or less.

(9) The display unit according to any one of (1) to (8), in which the seal layer includes polyurethane.

(10) The display unit according to (9), in which a molecular weight of the polyurethane is within a range of about 1000 to about 100000 both inclusive.

(11) The display unit according to any one of (1) to (10), in which the seal layer includes a colorant.

(12) The display unit according to any one of (1) to (11), in which the display layer includes a porous layer including migrating particles movable in a fibrous structure.

(13) An electronic apparatus provided with a display unit, the display unit including:

a first substrate;

a second substrate facing the first substrate;

a display layer provided between the first substrate and the second substrate and allowed to control light transmission or light reflection; and

a seal layer including an additive and provided between the first substrate and the display layer.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a first substrate;
a second substrate facing the first substrate;
a display layer provided between the first substrate and the second substrate and allowed to control light transmission or light reflection; and
a seal layer including an additive and provided between the first substrate and the display layer.

2. The display unit according to claim 1, wherein the additive has one or more kinds of acid structures.

3. The display unit according to claim 1, wherein an average molecular weight of the additive is within a range of about 100 to about 100000 both inclusive.

4. The display unit according to claim 1, wherein the additive is an anionic surfactant.

5. The display unit according to claim 1, wherein the additive is a nonionic surfactant.

6. The display unit according to claim 1, wherein the additive is a mixture of an anionic surfactant and a nonionic surfactant.

7. The display unit according to claim 1, wherein an HLB value of the additive is about 10 or more.

8. The display unit according to claim 1, wherein an addition amount of the additive is about 10 wt % or less.

9. The display unit according to claim 1, wherein the seal layer includes polyurethane.

10. The display unit according to claim 9, wherein a molecular weight of the polyurethane is within a range of about 1000 to about 100000 both inclusive.

11. The display unit according to claim 1, wherein the seal layer includes a colorant.

12. The display unit according to claim 1, wherein the display layer includes a porous layer including migrating particles movable in a fibrous structure.

13. An electronic apparatus provided with a display unit, the display unit comprising:
a first substrate;
a second substrate facing the first substrate;
a display layer provided between the first substrate and the second substrate and allowed to control light transmission or light reflection; and
a seal layer including an additive and provided between the first substrate and the display layer.
